(19) United States
(12) Patent Application Publication
(10) Pub. No.: US 2010/0257190 A1
(43) Pub. Date: Oct. 7, 2010

(54) Method and System for Querying a Health Level 7 (HL7) Data Repository

(76) Inventors: Ariel Farkash, Haifa (IL); Yonatan Maman, Hof Hacarmel (IL); Amnon Shabo, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 12/416,158

(22) Filed: Apr. 1, 2009

(51) Int. Cl. G06F 17/30; G06Q 50/00

(52) U.S. Cl. 707/760; 707/E17.014; 707/E17.044

(57) ABSTRACT

A method and system for querying a Health Level 7 (HL7) data repository which stores entries in HL7 Reference Information Model (RIM) terminology across multiple HL7 domains. The method includes: receiving a query input to retrieve data from the repository, wherein the query input is in a query language, converting the query input to a RIM query, and retrieving data from the repository using the RIM query. The RIM query expresses the query input using RIM physical classes and RIM codes. The method also includes converting retrieved RIM instances from the repository to a domain readable format. Providing the data repository includes receiving data for input in the data repository, wherein the data for input is defined at a domain level as a domain instance, and converting a domain instance to a RIM instance and inputting the RIM instance in the data repository.

### FIELD OF THE INVENTION

This invention relates to the field of Health Level 7 (HL7) data repositories. In particular, the invention relates to querying an HL7 data repository.

### BACKGROUND OF THE INVENTION

Health Level 7 (HL7) is a standards-producing body, which develops data standards for storing and exchanging information across the healthcare industry. The HL7 standards cover both clinical and administrative aspects of the healthcare industry, including laboratory, clinical genomics, medical records, patient care, pharmacy, public health reporting, regulated studies, accounts and billing, claims and reimbursement, patient administration and personnel management scheduling.

Starting from version 3 of the HL7 specifications (referred to as HL7 v3), all HL7 messages and data structures are specified and implemented as hierarchically structured Extensible Markup Language (XML) documents. All data structures are derived, using a well-defined methodology, from a single Reference Information Model (RIM). The RIM provides an explicit representation of the semantic and lexical connections that exist between the information items carried in the files of HL7 messages.

Health information is stored and exchanged using XML-based standards (for example, Clinical Document Architecture (CDA)) that specify the encoding, structure and semantics of the data. The CDA standard is part of the HL7 v3 standard specifications, which are based on the HL7 v3 Foundations, i.e. the Reference Information Model (RIM), Data Types, and Vocabularies. These foundations allow for modeling specific health domains over the same set of core classes, namely the RIM.

For example, instances compliant with the CDA standard are XML files organized in sections, each containing a narrative portion (readable to the user) along with structured data for machine proccessability. Structured data items are represented through the CDA model whose elements describe clinical document elements but they also correspond to the RIM by derivation (e.g., the element EncompassingEncounter in the header and the elements Encounter in the body are derivations of the RIM physical class PatientEncounter).

Health information repositories can be distinguished by the resolution and availability of retrieving structured data. In one known form of repository, whole RIM-based instances are retrieved regardless of their RIM derivation. For example, as in the IHE (Integrating the Healthcare Enterprise) Cross-Enterprise Document Sharing (XDS) integration standard. Some metadata fields are provided such as details on the patient, providers, encounters and given services that can be queried.

In another form of repository, RIM-based instances are shredded into a relational database, such as is the case of the IBM Clinical Genomics solution (IBM is a trade mark of International Business Machines Corporation). Then, optionally, a specific and reduced data mart (with non standard schema) is prepared for working with the data in a way that is more dedicated to the user proprietary data.

There are also tools to work with the RIM classes as Java objects (Java is a trade mark of Sun Microsystems Corporation) in memory through an application programming interface (API) developed by the HL7 Java Special Interest Group.

An aim of the present invention is to provide a RIM-based repository capable of persisting any domain instance using the physical RIM classes and yet querying the repository at the domain level.

### SUMMARY OF THE INVENTION

According to a first aspect of the present invention there is provided a method for querying a Health Level 7 (HL7) data repository, comprising: providing a data repository which stores entries in HL7 Reference Information Model (RIM) terminology across multiple HL7 domains; receiving a query input at a computer-based query application to retrieve data from the repository, wherein the query input is in a query language; converting the query input to a RIM query; retrieving data from the repository using the RIM query; wherein any of said steps are implemented in either of computer hardware or computer software and embodied in a computer-readable medium.

The RIM query may express the query input using RIM physical classes and RIM codes.

The method may also include converting RIM instances from the repository to a domain readable format.

A query input may specify one or more query domains.

Providing the data repository may include: receiving data for input in the data repository, wherein the data for input is defined at a domain level as a domain instance; converting a domain instance to a RIM instance; and inputting the RIM instance in the data repository.

Converting a domain instance to a RIM instance may express the domain instance using RIM physical classes and RIM codes with a clone name attribute that preserves the domain names.

Converting RIM instances to a domain readable format may convert to domain instances using the domain name.

Converting a domain instance to a RIM instance may include translating all domain specific clone names to RIM class names and adding any default or fixed attributes.

Converting a domain instance to a RIM instance may use Model Interchange Format (MIF).

According to a second aspect of the present invention there is provided a computer program product for querying a Health Level 7 (HL7) data repository, the computer program product comprising: a computer readable storage medium; computer program instructions operative to: provide a data repository which stores entries in HL7 Reference Information Model (RIM) terminology across multiple HL7 domains; receive a query input to retrieve data from the repository, wherein the query input is in a query language; convert the query input to a RIM query; retrieve data from the repository using the RIM query; wherein said program instructions are stored on said computer readable medium.

According to a third aspect of the present invention there is provided a method of providing a service to a customer over a network, the service comprising: providing a data repository which stores entries in HL7 Reference Information Model (RIM) terminology across multiple HL7 domains; receiving a query input at a computer-based query application to retrieve data from the repository, wherein the query input is in a query language; converting the query input to a RIM query; retrieving data from the repository using the RIM query; wherein any of said steps are implemented in either of computer hardware or computer software and embodied in a computer-readable medium.

According to a fourth aspect of the present invention there is provided a system for querying a Health Level 7 (HL7) data repository, comprising: a processor; a data repository which stores entries in HL7 Reference Information Model (RIM) terminology across multiple HL7 domains; a computer-based query input mechanism to retrieve data from the repository, wherein the query input is in a query language; a first conversion mechanism for converting the query input to a RIM query; a retrieval mechanism for retrieving data from the repository using the RIM query; wherein any of said data repository, query input mechanism, first conversion mechanism, and retrieval mechanism are implemented in either of computer hardware or computer software and embodied in a computer readable medium.

The system may include a second conversion mechanism for converting RIM instances from the repository to a domain readable format.

The data repository may include: a data receiving mechanism for input of data in the data repository, wherein data for input is defined at a domain level as a domain instance; a third conversion mechanism for converting a domain instance to a RIM instance; and an input mechanism for inputting the RIM instance in the data repository.

The third conversion mechanism for converting a domain instance to a RIM instance may expresses the domain instance using RIM physical classes and RIM codes with a clone name attribute that preserves the domain names.

The second conversion mechanism for converting RIM instances to a domain readable format may convert to domain instances using the domain names.

The third conversion mechanism for converting a domain instance to a RIM instance may include translating all domain specific class names to RIM class names and adding any default or fixed attributes.

The third conversion mechanism for converting a domain instance to a RIM instance may use Model Interchange Format (MIF).

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a schematic diagram showing an extract of the HL7 v3 Reference Information Model (RIM);

FIG. 2 is a schematic diagram of data input and retrieval from a RIM repository in accordance with the present invention;

FIG. 3 is a block diagram of a RIM repository and query system in accordance with the present invention;

FIG. 4 is a block diagram of a computer system in which the present invention may be implemented;

FIG. 5 is a flow diagram of a data input method in accordance with an aspect of the present invention;

FIG. 6 is a flow diagram of a query method in accordance with an aspect of the present invention;

FIG. 7 is a flow diagram of a conversion process in accordance with an aspect of the present invention; and

FIG. 8 is a schematic diagram of the conversion process in accordance with an aspect of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The RIM is an underlying reference model for deriving specific domain models. Various standardization working groups develop domain-specific standards by constraining the RIM and cloning the RIM classes in a way that accommodates the requirements of a specific domain.

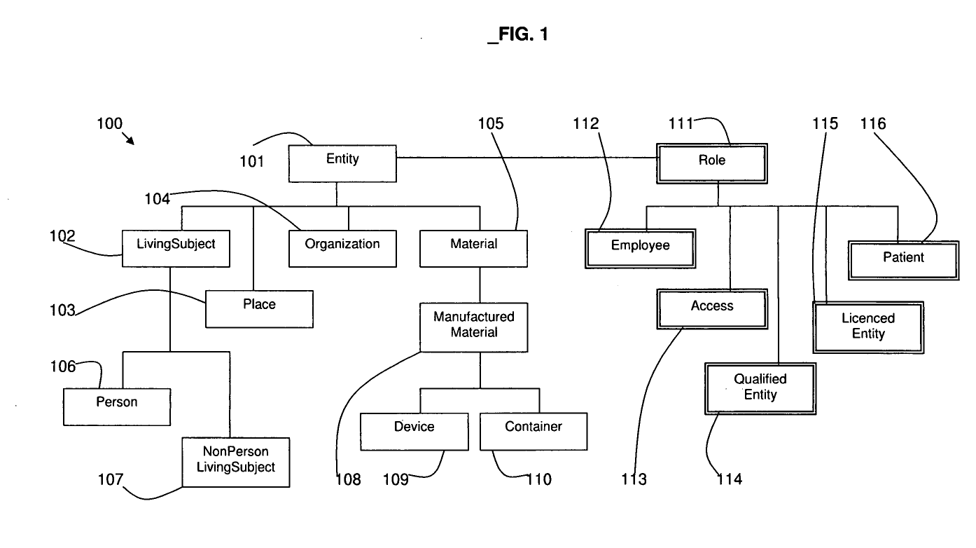

Referring to FIG. 1, an extract of the RIM 100 is shown. The RIM 100 has class elements arranged in a hierarchical tree structure. The class elements are grouped in categories, namely Entities, Roles, Acts, Infrastructure (Structured Documents), Infrastructure (Communications), and Other. The extract shown includes class entries in the categories of Entities (shown with a single border in the figure) and Roles (shown with a double border in the figure).

In the extract of the RIM 100 of FIG. 1, a root class element in the category of Entities which is “Entity” 101 with child elements “LivingSubject” 102, “Place” 103, “Organization” 104, and “Material” 105. The element “LivingSubject” 102 has child elements of “Person” 106, and “NonPersonLivingSubject” 107. The element “Material” 105 has a child element of “ManufacturedMaterial” 108 which in turn has child elements of “Device” 109 and “Container” 110.

There is a root class element in the category of Roles which is “Role” 111 with child elements of “Employee” 112, “Access” 113, “QualifiedEntity” 114, “LicencedEntity” 115, “Patient” 116.

Each class element in the RIM 100 has additional attributes which can be defined, but which are not shown in the figure.

Domains are either horizontal and used across the various clinical specialties (for example, medications, laboratory) or refer to specific clinical domains (for example, public health, genetics). The standard specifications are considered technology independent so that they can be implemented by various technologies. However, XML implementations (W3C XML Schemas) can be generated by the “XML ITS standard” (ITS=Implementation Technology Specification). In this process, the domain class names, which are referred to as clone names, are used as XML element names and so XML instances that comply with these schemas are also compliant with the ‘jargon’ of the domain.

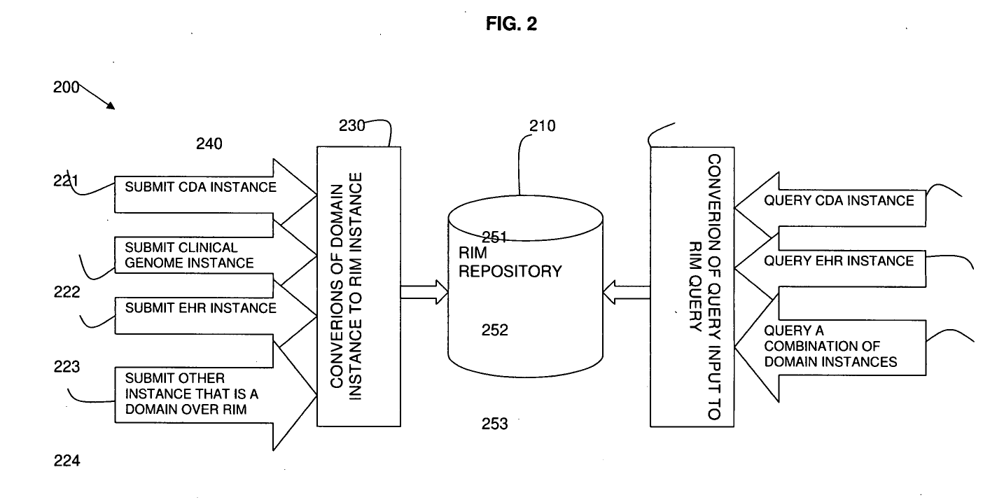

FIG. 2 shows a schematic diagram 200 showing the data input and retrieval from a RIM-based repository 210. Instances at domain level 221-224 are input. The domain level instances 221-224 may include a CDA instance 221, a Clinical Genome instance 222, an EHR (Electronic Health Record) instance 223, or another instance that is in a domain over RIM 224.

The domain level instances 221-224 are converted 230 to RIM instances and input into the RIM repository 210.

Queries 251-253 to the repository may be made over one or more domains. For example, a query of a CDA instance 251, a query of an EHR instance 252, or a query of a combination of domain instances 253.

The queries 251-253 are converted 240 to RIM terminology in order for a retrieval to be carried out from the RIM repository 210.

MIF (Model Interchange Format) is a proprietary XML used in HL7 in order to describe the HL7 v3 Foundations (RIM, Vocabularies, Data Types) and its derivative models. MIF is used for historical reasons and because XML schema is not expressive enough, i.e. not able to express some of the constraints in the domain models. The RIM meta-model is expressed in UML (Unified Modeling Language), but the domains are expressed in UML-like fashion, thus MIF is needed.

The RIM coremif is the MIF that describes the RIM meta-model itself (the UML diagram of the RIM). The vocabulary MIF is the MIF that describes the RIM terminology, giving exact coding hierarchy to RIM basic classes.

Domain MIF is a MIF (or actually at most times a set of MIFs with a single entry point MIF) that describes a given domain standard, for example Clinical Document Architecture (CDA) or Genetic Variation (GV). Every domain has its clones as part of the definition. Even if the clone equals the original RIM class it is defined as a clone in the MIF.

The described RIM-based repository stores XML instances that are converted to “RIM instances”. For example, the repository may use DB2 (DB2 is a trade mark of International Business Machines Corporation) pure XML capabilities to store the XML instances. Thus, the RIM-based repository can store any domain instance from any domain after converting it to a RIM instance. A RIM instance is an abstract instance that expresses the original domain instance using RIM physical classes and RIM codes along with the cloneName attribute that preserves the original domain names. It is abstract since RIM is but a meta model, thus cannot be instantiated

Querying the described RIM repository enables the capture of XML structures in various domains with different domain class names but the same structural attribute values. For example, query all Observation elements with classCode=ALRT associated (directly or indirectly) with another Observation element with classCode=DGIMG. This query will retrieve all issues found in diagnostic images and classified as alerts. This query is agnostic to the domain, which may be CDA, GV, Lab, etc.

A conversion between domain instances and RIM instances is described. The process takes a domain instance with domain elements such as SequenceVariation and transforms it to an instance that conforms directly to RIM, i.e., using merely RIM classes such as Observation (the type that SequenceVariation belongs to).

Since the RIM is an abstract model, the domain instance is converted while keeping the domain elements for reference. The process includes translation of all domain specific class names into RIM as well as filling in default/fixed attributes. The reverse conversion process to domain instance, i.e. recreating the original domain instance from a RIM instance is also carried out.

A conversion between a repository query input and RIM terminology is also described, so that a query to the RIM repository can be input in query language, but processed across the RIM repository.

The conversion or transformation is performed on the query in order to perform domain level queries on a RIM-based repository.

The basic processes for a RIM repository include the following:
Perform conversion of domain instances to RIM instances upon entry;
Perform conversion of domain queries to RIM queries allow querying the repository; and
Perform conversion of RIM instances to domain instances to allow retrieval of data in a meaningful way to the user.

Notice that this process essentially makes the RIM repository domain-independent, therefore one can later replace the RIM repository component and still maintain the integrity of the system.

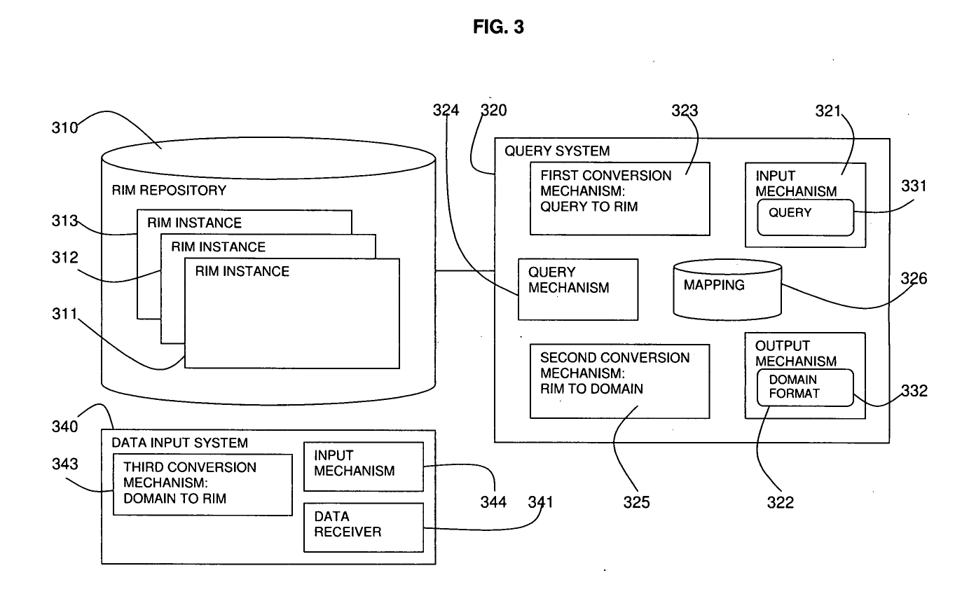

Referring to FIG. 3, a block diagram shows a RIM repository 310 with multiple RIM instances 311-313 defined across different domains.

A query system 320 coupled to or integral with the RIM repository 310 includes an input mechanism 321 for receiving a query 331 at a domain level and an output mechanism 322 for providing a response in user readable format 332 at a domain level.

A first conversion mechanism 323 converts incoming queries at domain level to RIM queries. A query mechanism 324 submits the converted query to the RIM repository 310. A second conversion mechanism 325 converts the retrieved repository RIM instance to a domain level response for output. The conversion mechanisms 323, 325 use a mapping 326 of RIM class codes and type codes to specialized RIM physical classes and to domain class codes/type codes.

The RIM repository 310 includes a data input system 340 with a data receiver 341 for receiving data for input into the repository at a domain level. The data input system 340 includes a third conversion mechanism 343 for converting the domain level data for input into RIM instances. The third conversion mechanism 343 also references the mapping 326 of domain class codes and RIM class codes. The data input system 340 includes a data input mechanism 344 for inputting the converted data into the RIM repository 310.

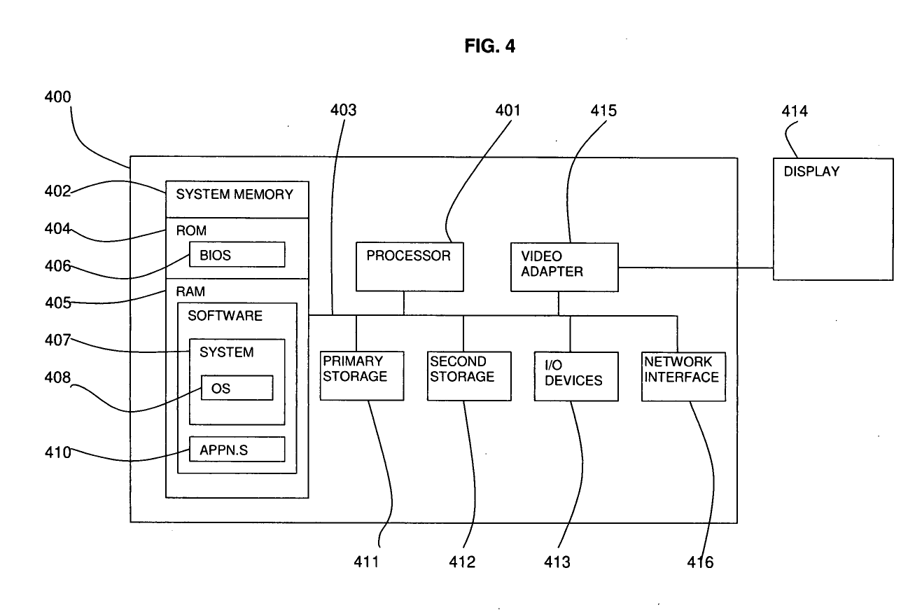

Referring to FIG. 4, an exemplary system for implementing a query system and data input system includes a data processing system 400 suitable for storing and/or executing program code including at least one processor 401 coupled directly or indirectly to memory elements through a bus system 403. The memory elements can include local memory employed during actual execution of the program code, bulk storage, and cache memories which provide temporary storage of at least some program code in order to reduce the number of times code must be retrieved from bulk storage during execution.

The memory elements may include system memory 402 in the form of read only memory (ROM) 404 and random access memory (RAM) 405. A basic input/output system (BIOS) 406 may be stored in ROM 404. System software 407 may be stored in RAM 405 including operating system software 408. Software applications 410 may also be stored in RAM 405.

The system 400 may also include a primary storage means 411 such as a magnetic hard disk drive and secondary storage means 412 such as a magnetic disc drive and an optical disc drive. The drives and their associated computer-readable media provide non-volatile storage of computer-executable instructions, data structures, program modules and other data for the system 400. Software applications may be stored on the primary and secondary storage means 411, 412 as well as the system memory 402.

The computing system 400 may operate in a networked environment using logical connections to one or more remote computers via a network adapter 416.

Input/output devices 413 can be coupled to the system either directly or through intervening I/O controllers. A user may enter commands and information into the system 400 through input devices such as a keyboard, pointing device, or other input devices (for example, microphone, joy stick, game pad, satellite dish, scanner, or the like). Output devices may include speakers, printers, etc. A display device 414 is also connected to system bus 403 via an interface, such as video adapter 415.

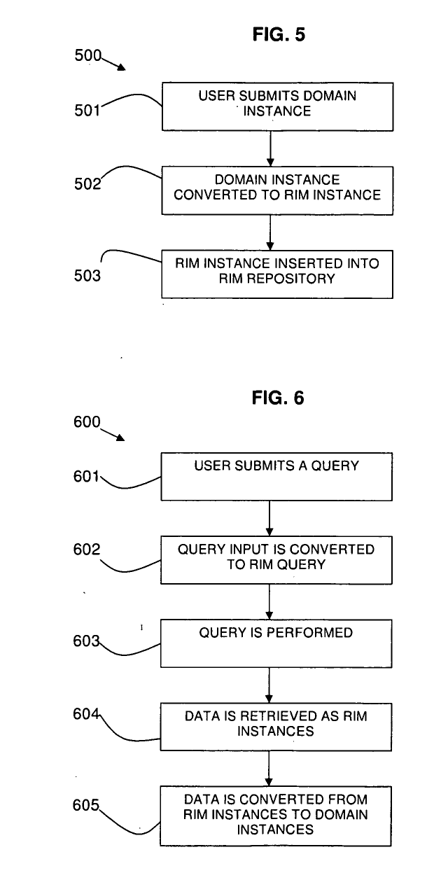

Referring to FIG. 5, a flow diagram 500 shows a method for data entry into a RIM repository. User submits a domain instance 501. This can be in any of the domains over RIM: CDA, Clinical Genomic (CG), Lab, Pharmacy, Public Health, etc. Conversion 502 is performed on the incoming domain instance to a RIM instance. The RIM instance is inserted 503 into RIM repository.

This may be by means of a simple pure XML insertion into DB2 v9, or an existing repository such as the IBM Clinical Genomics repository component, or another form of database.

Referring to FIG. 6, a flow diagram 600 shows a method for query and retrieval from a RIM repository. User submits 601 a query. A simple implementation can be an XQuery (W3C XML Query) on the database mentioned above using elements of the domain (i.e. XML elements of standards such as CDA, Lab or CG) or a more complex query depending on the repository used. The query is converted 602 to RIM terminology in order for the XQuery (or other) to be in the language of the RIM repository. The query is performed 603. Data is retrieved 604 and is converted 605 from RIM instances to domain instances, and thus will return as a domain instance (or part of instances, according to query).

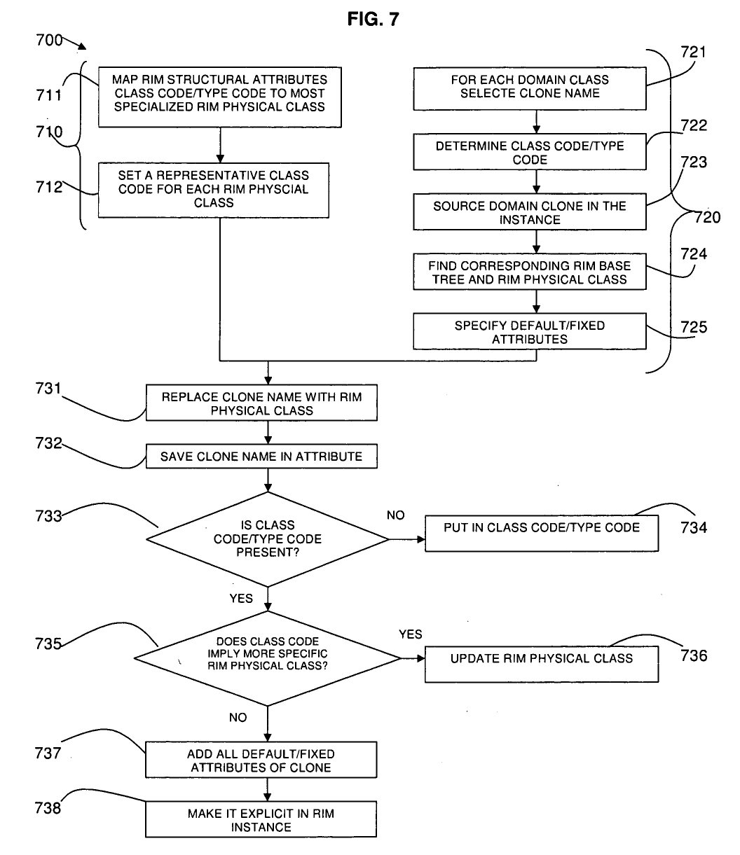

Referring to FIG. 7, a flow diagram 700 shows a method of technical conversion. The conversion process to RIM terminology from a domain instance or query input uses a common format called MIF (Model Interchange Format) developed to describe the standards specifications as well as the v3 foundations (mainly RIM and vocabularies), as follows:
1. As a RIM pre-processing stage 710, use the RIM core mif and vocabulary mif.
   i) Map 711 the RIM structural attributes classCode and typeCode to the most specialized RIM physical class. Example: DGIMG→Act::DiagnosticImage.
   ii) Also set 712 a representative classCode/typeCode for each RIM physical class.
2. As a domain pre-processing stage 720, use Domain MIF(s), for each domain class name (also called ‘clone’).
   i) Select clone name 721.
   ii) Determine 722 classCode/typeCode.
   iii) Source 723 domain clone, i.e. its parent element context in the instance.
   iv) Find 724 corresponding RIM base tree and RIM physical class.
   v) Specify additional attributes 725, e.g. default or fixed attributes.
3. For a domain instance or domain query 730.
   i) Replace 731 clone name with its corresponding RIM physical class and save 732 clone name in attribute cloneName.
   ii) Determine 733 if classCode/typeCode is not present, and if not, put in 734 determined classCode/typeCode from above.
   iii) Determine 735 if classCode implies a more specific RIM physical class than supplied by the clone, and if so, then update 736 it.
Example: observation classCode=“DGIMG”−regular→Observation classCode=“DGIMG”−additional→DiagnosticImage classCode=“DGIMG”
   iv) Add 737 all default/fixed attributes of clone and make it explicit 738 in RIM instance.

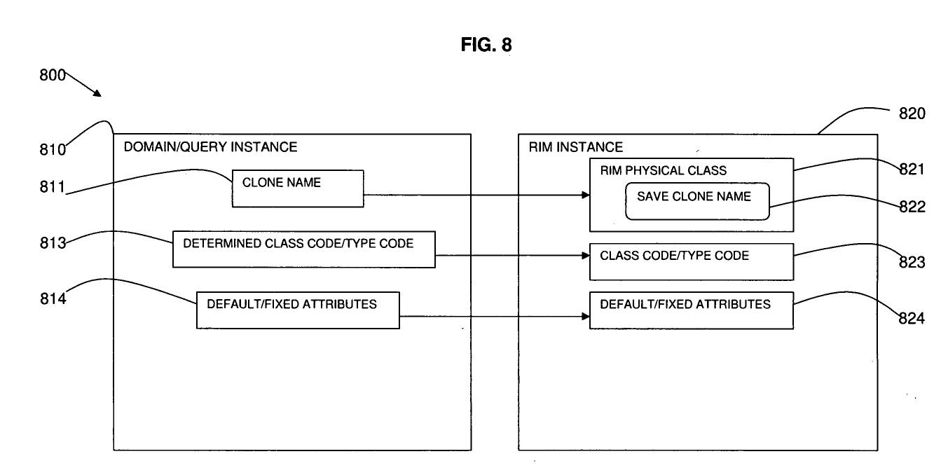

Referring to FIG. 8, a schematic diagram 800 shows the conversion of a domain/query instance 810 to a RIM instance 820. The domain/query instance 810 clone name 811 is mapped to the RIM physical class 821 and the clone name is saved 822 as an attribute. The domain class code/type code 813 are mapped to the RIM class code/type code 823. Add default/fixed attributes of clone 814 to RIM instance 824.

### EXAMPLE 1

### By Direct Xquery

A user familiar with a the structure of a certain CDA (Clinical Document Architecture) may request the substance administration observation for administering a drug called Prednisone. He might query for it directly in Xquery as follows:
“/ClinicalDocument/component/structuredBody/component/section[code/@code=‘10160-0’]/entry/substanceAdministration[consumable/manufacturedProduct/manufacturedLabeledDrug/code/@code=‘10312003’]”

This query will be converted to RIM terminology:
“/Document[@classCode=‘DOCCLIN’]/ActRelationship[@contextConductionInd=‘true’][@typeCode=‘COMP’]/Act[@classCode=‘DOCBODY’]/ActRelationship[@contextConductionInd=‘true’][@typeCode=‘COMP’]/Act[@classCode=‘DOCSECT’]/ActRelationship[@contextConductionInd=‘true’][@typeCode=‘COMP’]/SubstanceAdministration[@classCode=‘SBADM’][Participation[@typeCode=‘CSM’]/Role[@classCode=‘MANU’]/ManufacturedMaterial[@classCode=‘MMAT’]/code/@code=‘10312003’]”
   Which may be harder to read, but is controlled by the underlying HL7 v3 Vocabularies only.

The response from the RIM repository can be:

```
<SubstanceAdministration classCode=“SBADM”
cloneName=“substanceAdministration”
moodCode=“EVN”>
    <id root=“2.16.840.1.113883.19.8.1”/>
    <text>Prednisone 20mg qd</text>
    <effectiveTime institutionSpecified=“true” xsi:type=“PIVL_TS”>
        <period unit=“h” value=“24”/>
    </effectiveTime>
    <routeCode code=“PO” codeSystem=“2.16.840.1.113883.5.112”
    codeSystemName=“RouteOfAdministration”/>
    <doseQuantity unit=“mg” value=“20”/>
    <Participation cloneName=“consumable” typeCode=“CSM”>
        <Role classCode=“MANU”
        cloneName=“manufacturedProduct”>
            <ManufacturedMaterial classCode=“MMAT”
            cloneName=“manufacturedLabeledDrug”
            determinerCode=“KIND”>
                <code code=“10312003”
                codeSystem=“2.16.840.1.113883.6.96”
                codeSystemName=“SNOMED CT”
                displayName=“Prednisone preparation”/>
            </ManufacturedMaterial>
        </Role>
    </Participation>
</SubstanceAdministration>
```

Which is not an answer the user can (or wants to) understand. This can be converted from RIM terminology to give:

```
<substanceAdministration classCode=“SBADM” moodCode=“EVN”>
    <text>Prednisone 20mg qd</text>
    <effectiveTime xsi:type=“PIVL_TS” institutionSpecified=“true”>
    <period value=“24” unit=“h”/>
    </effectiveTime>
    <routeCode code=“PO” codeSystem=“2.16.840.1.113883.5.112”
    codeSystemName=“RouteOfAdministration”/>
    <doseQuantity value=“20” unit=“mg”/>
    <consumable>
        <manufacturedProduct>
            <manufacturedLabeledDrug>
                <code code=“10312003”
                codeSystem=“2.16.840.1.113883.6.96”
                codeSystemName=“SNOMED CT”
                displayName=“Prednisone preparation”/>
            </manufacturedLabeledDrug>
        </manufacturedProduct>
    </consumable>
</substanceAdministration>
```

### EXAMPLE 2

### By Means of QED (Query for Existing Data)

Another example is a QED request for a heart beat of patient. The result must be returned as a clinical statement

Since there are many domain models that include the Clinical Statement shared model, a search of the RIM repository may be made for all occurrences of specific clinical statement pattern regardless of their containing domain and return it in QED required message format.

A query system may be provided as a service to a customer over a network.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for querying a Health Level 7 (HL7) data repository, comprising:
providing a data repository which stores entries in HL7 Reference Information Model (RIM) terminology across multiple HL7 domains;
receiving a query input at a computer-based query application to retrieve data from the repository, wherein the query input is in a query language;
converting the query input to a RIM query;
retrieving data from the repository using the RIM query;
wherein any of said steps are implemented in either of computer hardware or computer software and embodied in a computer-readable medium.

2. The method as claimed in claim 1, wherein the RIM query expresses the query input using RIM physical classes and RIM codes.

3. The method as claimed in claim 1, including:
converting RIM instances from the repository to a domain readable format.

4. The method as claimed in claim 1, wherein a query input specifies one or more query domains.

5. The method as claimed in claim 1, wherein providing the data repository includes:
receiving data for input in the data repository, wherein the data for input is defined at a domain level as a domain instance;
converting a domain instance to a RIM instance; and
inputting the RIM instance in the data repository.

6. The method as claimed in claim 5, wherein converting a domain instance to a RIM instance expresses the domain instance using RIM physical classes and RIM codes with a clone name attribute that preserves the domain names.

7. The method as claimed in claim 6, wherein converting RIM instances to a domain readable format converts to domain instances using the domain name.

8. The method as claimed in claim 5, wherein converting a domain instance to a RIM instance includes translating all domain specific clone names to RIM class names and adding any default or fixed attributes.

9. The method as claimed in claim 5, wherein converting a domain instance to a RIM instance uses Model Interchange Format (MIF).

10. A computer program product for querying a Health Level 7 (HL7) data repository, the computer program product comprising:
a computer readable medium;
computer program instructions operative to:
provide a data repository which stores entries in HL7 Reference Information Model (RIM) terminology across multiple HL7 domains;
receive a query input to retrieve data from the repository, wherein the query input is in a query language;
convert the query input to a RIM query;
retrieve data from the repository using the RIM query;
wherein said program instructions are stored on said computer readable medium.

11. A method of providing a service to a customer over a network, the service comprising:
providing a data repository which stores entries in HL7 Reference Information Model (RIM) terminology across multiple HL7 domains;
receiving a query input at a computer-based query application to retrieve data from the repository, wherein the query input is in a query language;
converting the query input to a RIM query;
retrieving data from the repository using the RIM query;
wherein any of said steps are implemented in either of computer hardware or computer software and embodied in a computer-readable medium.

12. A system for querying a Health Level 7 (HL7) data repository, comprising:
a processor;
a data repository which stores entries in HL7 Reference Information Model (RIM) terminology across multiple HL7 domains;
a computer-based query input mechanism to retrieve data from the repository, wherein the query input is in a query language;
a first conversion mechanism for converting the query input to a RIM query;
a retrieval mechanism for retrieving data from the repository using the RIM query;
wherein any of said data repository, query input mechanism, first conversion mechanism, and retrieval mechanism are implemented in either of computer hardware or computer software and embodied in a computer readable medium.

13. The system as claimed in claim 12, including:
a second conversion mechanism for converting RIM instances from the repository to a domain readable format.

14. The system as claimed in claim 12, wherein a query input specifies one or more domains.

15. The system as claimed in claim 12, wherein the data repository includes:
a data receiving mechanism for input of data in the data repository, wherein data for input is defined at a domain level as a domain instance;
a third conversion mechanism for converting a domain instance to a RIM instance; and
an input mechanism for inputting the RIM instance in the data repository.

16. The system as claimed in claim 15, wherein the third conversion mechanism for converting a domain instance to a RIM instance expresses the domain instance using RIM physical classes and RIM codes with a clone name attribute that preserves the domain names.

17. The system as claimed in claim 15, wherein the second conversion mechanism for converting RIM instances to a domain readable format converts to domain instances using the domain names.

18. The system as claimed in claim 15, wherein the third conversion mechanism for converting a domain instance to a RIM instance includes translating all domain specific clone names to RIM class names and adding any default or fixed attributes.

19. The system as claimed in claim 15, wherein the third conversion mechanism for converting a domain instance to a RIM instance uses Model Interchange Format (MIF).
